(19) United States
(12) Patent Application Publication
(10) Pub. No.: US 2010/0276936 A1
(43) Pub. Date: Nov. 4, 2010

(54) Air and fluid energy recovery device

(76) Inventor: John J. Golgoski, JR., Kingston, NY (US)

Correspondence Address: SAILE ACKERMAN LLC, 28 DAVIS AVENUE, POUGHKEEPSIE, NY, 12603, US

(21) Appl. No.: 12/387,372

(22) Filed: May 1, 2009

(51) Int. Cl. F03D 9/00

(52) U.S. Cl. 290/55

(57) ABSTRACT

This invention provides a device and a method for recovering and harvesting wind and fluid energy. The basic building block of the invention is the energy recovery module which are cascaded and used in either an open or closed mode. The method and device are used to recover wind energy from roadway and train traffic air movement. Also, the method and device are used to recover fluid energy from fluid flow movement. A key advantage is the modular, scalable design, which extends the number of useful embodiments.

### BACKGROUND OF THE INVENTION

1. Field of the Invention

This invention relates to a device and a method for recovering and harvesting wind and fluid energy. More particularly, this invention relates to a device and a method for recovering and harvesting wind energy from roadway and train traffic air movement. Also, more particularly, this invention relates to a device and a method for recovering and harvesting energy from water-flow movement.

2. Description of Related Art

Current practice in the field of energy harvesting utilizes large windmill-type energy recovery devices which are placed over a roadway. Other prior art are listed below.
U.S. Pat. No. 4,211,078—Dynamic Power Source (Bass) describes a cylinder which is arranged to pump hydraulic fluid into a pressure accumulator. The stored hydraulic fluid operates a hydraulic motor to drive an alternator to generate electric power.
U.S. Pat. No. 7,332,078—Apparatus for recovering energy from turbulence created within an aerobic biological reactor (Murphy) describes a method and apparatus that takes advantage of both the aeration dynamics provided along with the free resulting hydro energy created by the flotation dynamics of the air bubbles and most importantly recover more energy than is required to operate the aeration basin as a result of the bonus hydro energy realized.
U.S. Pat. No. 7,081,688—Energy recovery apparatus and method of operating energy recovering apparatus (Satou et al.) describes a system to recover unutilized energy as electric power in hydraulic turbine power generation. A hydraulic turbine driven generator is provided on a lower portion of the second water feed pipe at such a position as to recover the potential energy of the water discharged from the air conditioning loads.
Web Links:
1) “Hot-air powered railway to harvest energy from cars”
   http://www.theregister.co.uk/2007/05/02/architects like infrastructure shocker/
2) “Proposals would turn highways into wind farms”
   http://www.engadget.com/2007/04/30/proposals-would-turn-highways-into-wind-farms/
3) “Pico Hydro Power”—Wikipedia
   http://en.wikipedia.org/wiki/Pico hydro
4) “Micro Hydro Power”—Wikipedia
   http://en.wikipedia.org/wiki/Micro hydro

### BRIEF SUMMARY OF THE INVENTION

It is the objective of this invention to provide a device and a method for recovering and harvesting wind and fluid energy. The invention also provides a device and a method for recovering and harvesting wind energy from roadway and train traffic air movement. The invention also provides for the recovery and harvesting of energy from water flow movement.

The objects of this invention are achieved by a modular section with one or more movable propellers mounted inside of the modular section. The modular section also contains one or more microgenerators attached to the movable propellers. Wind or fluid which enters the modular section will move the movable propellers. This propeller movement will cause the attached microgenerators to produce electricity.

### BRIEF DESCRIPTION OF THE DRAWINGS

FIG. 1a shows the main building block of the invention which is the energy recovery module. It is shown in its open mode.

FIG. 1b shows the microgenerator mounted inside of the pipe section.

FIG. 1c shows the main building block of the invention which is the energy recovery module. It is shown in its closed mode.

FIG. 2 is a roadside embodiment the invention.

FIG. 3 is a waterway, closed pipe embodiment of the invention.

FIG. 4 is a vehicle embodiment of the invention.

### DETAILED DESCRIPTION OF THE INVENTION

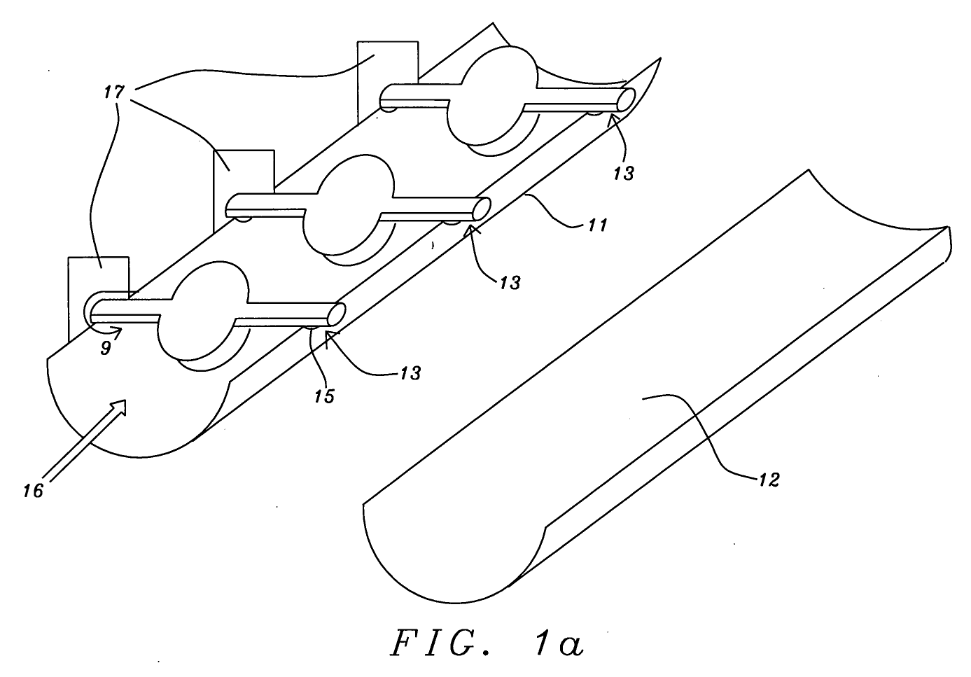

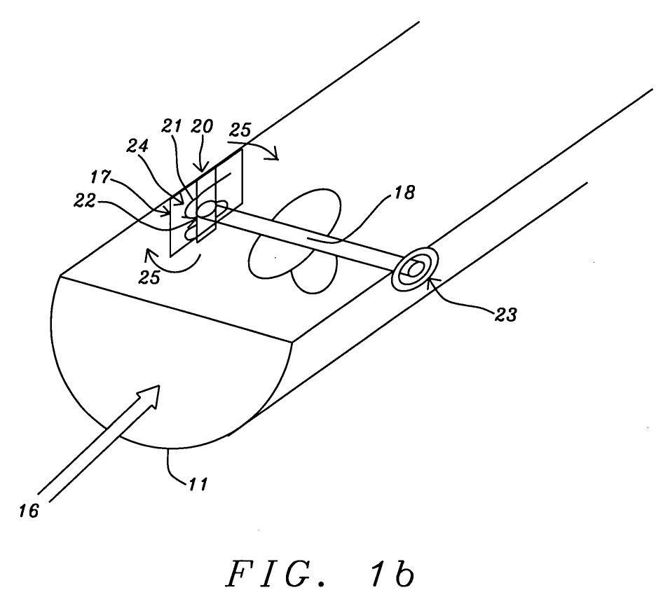

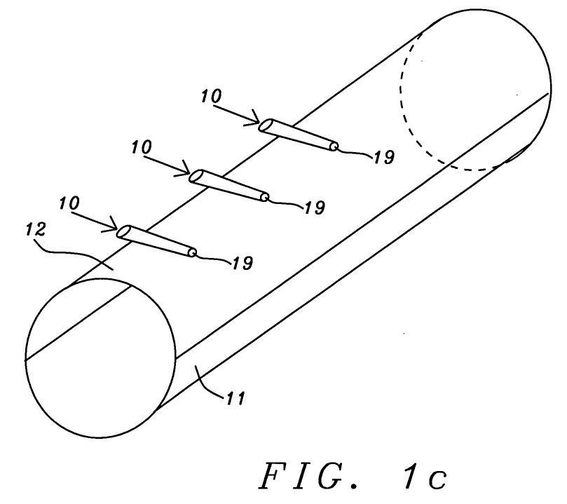

FIG. 1a shows the two halves of the main embodiment device of the invention. The two halves of the device are connected with a hinged which allows the two halves to close forming a pipe section. FIG. 1a shows the open mode of the device. The top half of the device pipe 12 is shown. In addition, the bottom pipe 11 is shown. The bottom pipe 11 contains three movable, spinable propeller blades 13. The propeller blade subassembly 13 consists of a cylindrical dowel with 3 or more propeller blades protruding from the dowel or axis 18. The blades are custom-cut to fit inside the device pipe diameter. The axes, blades, and pipe are made of highly durable polymer, fiberglass, metal, or wheat-grass.

FIG. 1a shows three propeller blade sub assemblies. However, the device subassembly 12 plus 11 can contain 1,2,3 or more propeller blade sub assemblies 13. Each of these propeller blade subassemblies such as 13 are able to freely spin as they are supported by the u-shaped grooves 14,15 located in the bottom pipe 11. The blade and axes can interface with the pipe via a ball-bearing wheel assembly. As wind or fluid 16 enters the pipe sub section 11, the propeller blade subassemblies will spin. Each of these propeller subassemblies is attached to microgenerators 17 which will generate electricity when the propeller subassemblies spin. The microgenerators are attached to the blade axes via a quick-connect mechanism. The maximum speed that the blades should spin would be dictated by spin burn-out tolerance of the microgenerators. The electricity generated by these microgenerators is summed and collected for transmission, storage and usage. A new microgenerator developed at Georgia Tech could be used for the invention. The microgenerator is about 10 millimeters wide, or about the size of a dime. The microgenerator produces useful amounts of electricity by spinning a small magnet above a mesh of coils fabricated on a chip. The device's magnet spins at 100,000 revolutions per minute (rpm), much faster than the 3,000 rpm of an average car engine. The microgenerator is capable of producing 1.1 watts of power, which is typically enough to operate a cell phone. (http://www.gatech.edu/newsroom/release.html?id=490). Similar microgenerators by other manufacturers could be used, as long as they are small in size and produce similar power output.

FIG. 1b illustrates the microgenerator 17 mounted inside the pipe 11. The microgenerator is attached to the blade axis 18 via a quick-connect mechanism 22. The axis 18 is connected to the pipe via a ball-bearing wheel assembly 23. The microgenerator 17 contains a mesh of coils 21 fabricated on a chip 24. The clockwise motion of the axis caused by the air or fluid motion 16 caused the magnet 20 to spin above the mesh of coils 21 to generate electricity.

FIG. 1c shows the bottom 11 and top 12 halves of the pipe device in a closed mode. These pipe sections are cylindrical, rectangular or square tubular sections. In addition, FIG. 1c shows compressed air being funneled or forced into the holes 18 going into the pipe device. This optional embodiment of the invention allows externally generated compressed air or fluid to supplement the ambient wind or fluid movement 16 that is being captured or harvested by the pipe modular device 11, 12. The supplemental compressed air or fluid 13 may be needed when ambient wind or fluid flow 16 are minimal or when an extra peak level of electrical generation is required from the pipe subassemblies.

The pipe subassemblies in FIG. 1a, 1b, or 1c are designed to be cascaded in serial strings of pipe subassemblies. If any one or more pipe assemblies become damaged, defective or unusable for a period of time, the cascaded series of pipe subassemblies will continue to operate and to sum their electricity which is generated. A damaged energy recovery module section will automatically switch into bypass mode if the module detects that there is a fault inside the module. Alternatively, the damaged module are manually switched into bypass mode if necessary. The microgenerators are protected from wind or water if they were located inside the pipe in the closed-pipe mode. In the open-pipe mode, the microgenerators and blades are protected via a weatherized polycoat material.

The pipe subassemblies of FIG. 1a, 1b, or 1c are used to capture wind energy from passing cars on roadsides or from trains and subways for example. Similarly, the pipe subassemblies are used to capture fluid flow by being located in water aqueducts. These are just a few of many applications of this invention.

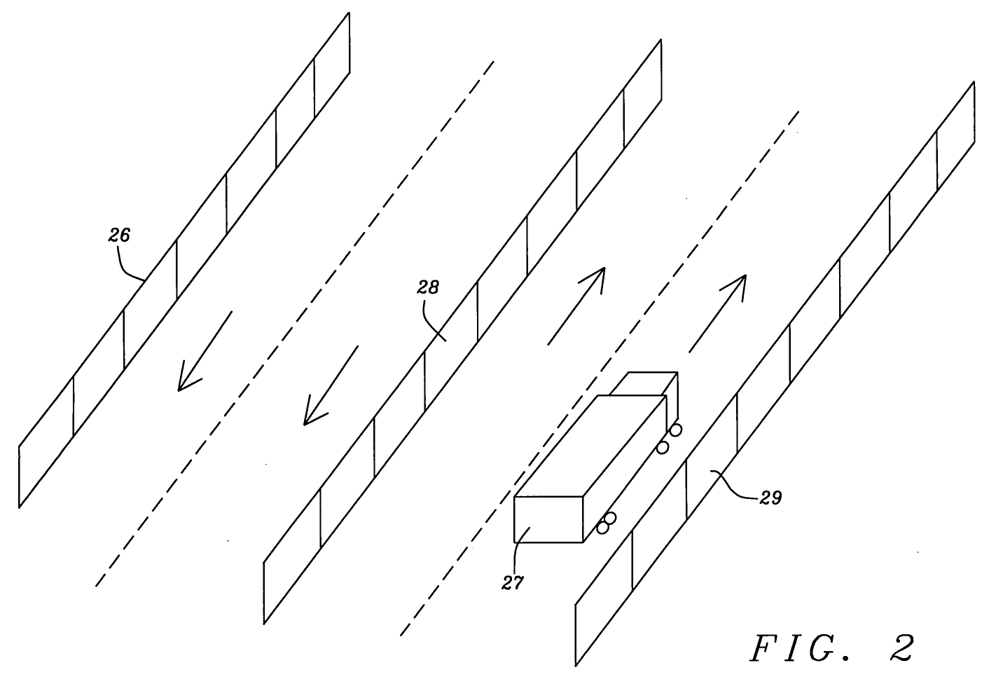

FIG. 2 shows a perspective drawing of a 4-lane divided highway. A cascade of modules 21 is shown. Seven modules cascaded are shown on the upper side of the roadway. A cascade of seven energy recovery modules 23 is shown in the dividing median of the roadway.

The energy recover modules 23 placed in the median divider are dual-sided or two energy recovery modules placed back-to-back, so as to be able to harvest the wind energy from the traffic in both opposing lanes. A cascade of seven energy modules 24 is shown adjacent to a traffic lane with a moving truck 22.

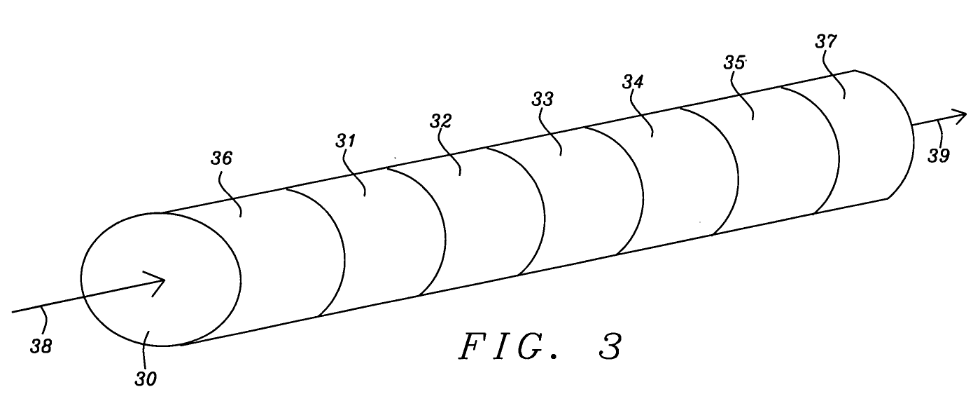

FIG. 3 shows five sections or energy recovery modules 31, 32, 33, 34 and 35 placed between two end sections 36, 39 of a water or fluid pipe 30. The water flows into the pipe at 39. It should be noted that this water pipe embodiment of the energy recovery module uses the basic module in a closed configuration. This is as opposed to the open configuration of the basic energy recovery module which is used in the roadway and train way embodiments.

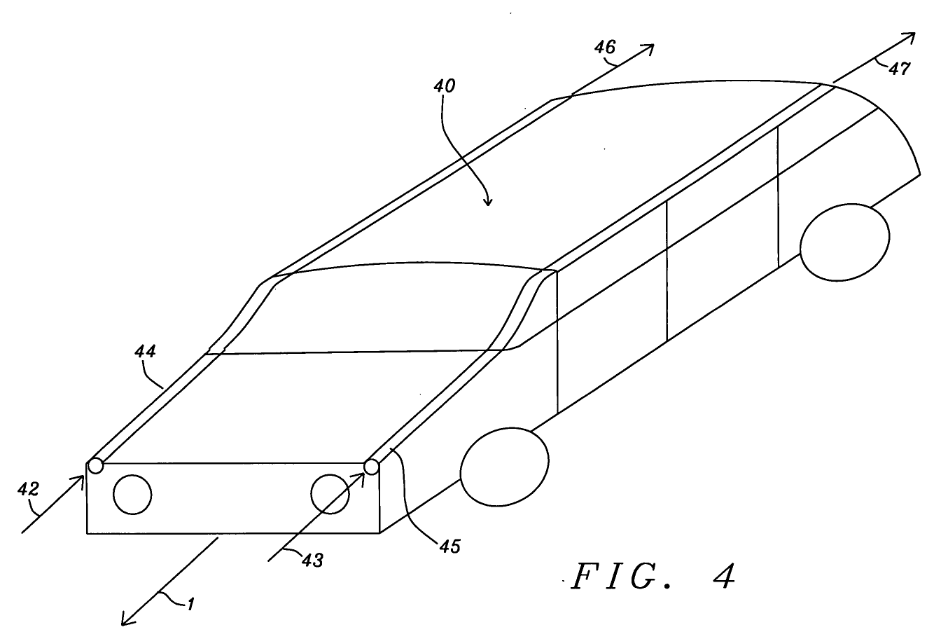

FIG. 4 shows another airflow embodiment of the invention related to moving vehicles 40. Vehicle airflow pipes 44, 45 are designed and built into the vehicle's hood and roof as shown in FIG. 4. These vehicle airflow pipes have wind inputs 42, 43 and wind outlets 46, 47. Each vehicle airflow pipe contains several sections of energy recovery modules. This airflow embodiment uses closed energy recovery modules. As the vehicle 40 moves 1 in the direction shown, ambient air is forced into the pipe intake openings 42, 43. This air or wind which is recovered travels through the pipes and energy recovery sections, spinning the propellers inside each of the energy recovery modules. The spinning of these propellers moves the input of the microgenerators shown in FIG. 1a. The electricity from each microgenerator is summed. This aggregate electricity is either stored in batteries or some other medium, transmitted to a regional electricity grid for distribution or used immediately by the vehicle.

The key advantages of this device and method are as follows. The basic energy recovery module section or a serial cascade of the modules are adaptable to many applications and uses. The cascaded sections are built into cars, trains, or any moving objects. The cascaded section are stationary, allowing wind or fluid flow to pass through them. In addition, cascaded sections of two or more of the basic energy recovery modules continue to operate if one or more modules are damaged. The invention also provides a means for external forced wind or fluid to enter the energy recovery module to spin the propellers during lulls in ambient wind and fluid flow.

While this invention has been particularly shown and described with Reference to the preferred embodiments thereof, it will be understood by those Skilled in the art that various changes in form and details may be made without Departing from the spirit and scope of this invention.

What is claimed is:

1. An energy recovery and harvesting device comprising:
one or more modular sections of pipe,
one or more movable propellers blades connected to propeller blade axes are mounted inside of said modular section of pipe and
one or more microgenerators attached to said movable propellers blades,
wherein wind or fluid enters said modular section and moves said movable propeller blades, wherein movement of said movable propeller blades causes said microgenerators to produce electricity.

2. The energy recovery and harvesting device of claim 1 wherein said modular section are cascaded to one or more other modular sections.

3. The energy recovery and harvesting device of claim 2 wherein said generated electricity from said movable microgenerators from one or more said modular sections are combined or added together resulting in an aggregate amount of generated electricity.

4. The energy recovery and harvesting device of claim 1 wherein said modular section are cylindrical, rectangular or square tubes wherein said moveable propeller blades and said microgenerators are mounted either inside said modular section of pipe or outside said modular section of pipe, wherein said axes, blades, and pipe are made of polymer, fiberglass, metal, wheat-grass or other highly durable material, and wherein said microgenerators are attached to said blade axes via a quick-connect mechanism.

5. The energy recovery and harvesting device of claim 4 wherein said modular section are cut in half and hinged at one edge resulting in openable and closable cylindrical, rectangular or square tubular sections.

6. The energy recovery and harvesting device of claim 1 wherein said modular section has an external opening which allows external compressed air or fluid to be forced into said molecular section in order to rotate said movable propeller blades.

7. The energy recovery and harvesting device of claim 5 wherein said openable rectangular or square tubular sections are mounted along a roadside or train track in order to recover and harvest wind energy produced by moving vehicles or trains, wherein said wind energy will enter said modular sections to generate electricity.

8. The energy recovery and harvesting device of claim 4 wherein said closed rectangular or square tubular sections are placed in a setting where fluid flows into said sections in order to recover and harvest moving fluid energy produced by currents in bodies of water, by gravity fed fluid or by fluid flow in water pipes or aqueducts, wherein said flow energy will enter said modular sections to generate electricity.

9. The energy recovery and harvesting device of claim 5 wherein said closed rectangular or square tubular sections are mount along a hood and roof of a vehicle such as a car, bus, track or train in order to recover and harvest wind energy produced by airflow against moving vehicles or trains, wherein said wind energy will enter said modular sections to generate electricity.

10. The energy recovery and harvesting device of claim 3 wherein said generated electricity from said movable microgenerators continues to sum or add in a bypass mode, if one or more cascaded sections are damaged or defective, wherein if said sections damaged, said section will detect the fault and automatically switch itself into said bypass mode, wherein said section can manually be switched into said bypass mode.

11. A method of energy recovery and harvesting comprising the steps of:
providing one or more modular sections of pipe,
providing one or more movable propeller blades connected to propeller blade axes are mounted inside of said modular section and
providing one or more microgenerators attached to said movable propeller blades,
wherein wind or fluid enters said modular section and moves said movable propeller blades, wherein movement of said movable propeller blades causes said microgenerators to produce electricity.

12. The method of energy recovery and harvesting of claim 11 wherein said modular section are cascaded to one or more other modular sections.

13. The method of energy recovery and harvesting of claim 12 wherein said generated electricity from said movable microgenerators from one or more said modular sections are combined or added together resulting in an aggregate amount of generated electricity.

14. The method of energy recovery and harvesting of claim 11 wherein said modular section are cylindrical, rectangular or square tubes wherein said moveable propeller blades and said microgenerators are mounted either inside said modular sections or outside said modular sections, wherein said axes, blades, and pipe are made of polymer, fiberglass, metal, wheat-grass or other highly durable material, and wherein said microgenerators are attached to said blade axes via a quick-connect mechanism.

15. The method of energy recovery and harvesting of claim 14 wherein said modular section are cut in half and hinged at one edge resulting in openable and closable cylindrical, rectangular or square tubular sections.

16. The method of energy recovery and harvesting of claim 11 wherein said modular section has an external opening which allows external compressed air or fluid to be forced into said molecular section in order to rotate said movable propeller blades.

17. The method of energy recovery and harvesting of claim 15 wherein said openable rectangular or square tubular sections are mounted along a roadside or train track in order to recover and harvest wind energy produced by moving vehicles or trains, wherein said wind energy will enter said modular sections to generate electricity.

18. The method of energy recovery and harvesting of claim 14 wherein said closed rectangular or square tubular sections are placed in a setting where fluid flows into said sections in order to recover and harvest moving fluid energy produced by currents in bodies of water, by gravity fed fluid or by fluid flow in water pipes or aqueducts, wherein said flow energy will enter said modular sections to generate electricity.

19. The method of energy recovery and harvesting of claim 15 wherein said closed rectangular or square tubular sections are mount along a hood and roof of a vehicle such as a car, bus, track or train in order to recover and harvest wind energy produced by airflow against moving vehicles or trains, wherein said wind energy will enter said modular sections to generate electricity.

20. The method of energy recovery and harvesting of claim 13 wherein said generated electricity from said movable microgenerators continues to sum or add if one or more cascaded sections are damaged or defective, wherein if said sections damaged, said section will detect the fault and automatically switch itself into said bypass mode, wherein said section can manually be switched into said bypass mode.
